(19) United States
(12) Patent Application Publication
(10) Pub. No.: US 2024/0267531 A1
(43) Pub. Date: Aug. 8, 2024

(54) SYSTEMS AND METHODS FOR OPTIMIZING A LOSS FUNCTION FOR VIDEO CODING FOR MACHINES

(71) Applicant: OP Solutions, LLC, Amherst, MA (US)

(72) Inventors: Hari Kalva, Boca Raton, FL (US); Borivoje Furht, Boca Raton, FL (US); Velibor Adzic, Canton, GA (US)

(73) Assignee: OP Solutions, LLC, Amherst, MA (US)

(21) Appl. No.: 18/637,785

(22) Filed: Apr. 17, 2024

Related U.S. Application Data
(63) Continuation of application No. PCT/US22/46828, filed on Oct. 17, 2022.
(60) Provisional application No. 63/256,677, filed on Oct. 18, 2021.

(51) Int. Cl. H04N 19/147; H04N 19/136; H04N 19/42; H04N 19/44

(52) U.S. Cl. CPC H04N 19/147; H04N 19/136; H04N 19/42; H04N 19/44

(57) ABSTRACT

Aspects relate to systems and methods for optimizing a loss function for video coding for machines. An exemplary system includes a computing device including circuitry and configured to receive an input video, extract a feature map as a function of the input video and at least a feature extraction parameter, encode a feature layer as a function of the feature map, calculate a loss function as a function of the feature layer, and optimize the at least a feature extraction parameter as a function of the loss function.

### CROSS-REFERENCE TO RELATED APPLICATIONS

The present application is a continuation of PCT/US2022/046828 filed on Oct. 17, 2022, and entitled SYSTEMS AND METHODS FOR OPTIMIZING A LOSS FUNCTION FOR VIDEO CODING FOR MACHINES, which application claims the benefit of priority to U.S. Provisional patent application Ser. No. 63/256,677 filed on Oct. 18, 2021, and entitled “SYSTEMS AND METHODS FOR OPTIMIZING A LOSS FUNCTION FOR VIDO CODING FOR MACHINES” the disclosure of which is hereby incorporated by reference in its entirety.

### FIELD OF THE INVENTION

The present invention generally relates to the field of video encoding and decoding. In particular, the present invention is directed to systems and methods for optimizing a loss function for video coding for machines.

### BACKGROUND

A video codec can include an electronic circuit or software that compresses or decompresses digital video. It can convert uncompressed video to a compressed format or vice versa. In the context of video compression, a device that compresses video (and/or performs some function thereof) can typically be called an encoder, and a device that decompresses video (and/or performs some function thereof) can be called a decoder.

A format of the compressed data can conform to a standard video compression specification. The compression can be lossy in that the compressed video lacks some information present in the original video. A consequence of this can include that decompressed video can have lower quality than the original uncompressed video because there is insufficient information to accurately reconstruct the original video.

There can be complex relationships between the video quality, the amount of data used to represent the video (e.g., determined by the bit rate), the complexity of the encoding and decoding algorithms, sensitivity to data losses and errors, ease of editing, random access, end-to-end delay (e.g., latency), and the like.

Motion compensation can include an approach to predict a video frame or a portion thereof given a reference frame, such as previous and/or future frames, by accounting for motion of the camera and/or objects in the video. It can be employed in the encoding and decoding of video data for video compression, for example in the encoding and decoding using the Motion Picture Experts Group (MPEG)'s advanced video coding (AVC) standard (also referred to as H.264). Motion compensation can describe a picture in terms of the transformation of a reference picture to the current picture. The reference picture can be previous in time when compared to the current picture, from the future when compared to the current picture. When images can be accurately synthesized from previously transmitted and/or stored images, compression efficiency can be improved.

Recent trends in robotics, surveillance, monitoring, Internet of Things, etc. introduced use cases in which significant portion of all the images and videos that are recorded in the field is consumed by machines only, without ever reaching human eyes. Those machines process images and videos with the goal of completing tasks such as object detection, object tracking, segmentation, event detection etc. Recognizing that this trend is prevalent and will only accelerate in the future, international standardization bodies established efforts to standardize image and video coding that is primarily optimized for machine consumption. For example, standards like JPEG AI and Video Coding for Machines (“VCM”) are initiated in addition to already established standards such as Compact Descriptors for Visual Search, and Compact Descriptors for Video Analytics.

As used herein, the terms video coding for machines and VCM are intended to refer generally to the coding of video and image data for consumption by machines instead of human viewers. The present methods are applicable to the developing VCM standard, but are not limited thereto. While this disclosure focuses on video coding for machines, it will be appreciated that the teachings herein are fully applicable to hybrid systems in which video content is encoded and decoded for both human and machine consumption.

### SUMMARY OF THE DISCLOSURE

In an aspect a system for optimizing a loss function for video coding for machines includes a computing device including circuitry and configured to receive an input video, extract a feature map as a function of the input video and at least a feature extraction parameter, encode a feature layer as a function of the feature map, calculate a loss function as a function of the feature layer, and optimize the at least a feature extraction parameter as a function of the loss function.

In another aspect a method of optimizing a loss function for video coding for machines includes receiving, using a computing device, an input video, extracting, using the computing device, a feature map as a function of the input video and at least a feature extraction parameter, encoding, using the computing device, a feature layer as a function of the feature map, calculating, using the computing device, a loss function as a function of the base feature layer, and optimizing, using the computing device, the at least a feature extraction parameter as a function of the loss function.

These and other aspects and features of non-limiting embodiments of the present invention will become apparent to those skilled in the art upon review of the following description of specific non-limiting embodiments of the invention in conjunction with the accompanying drawings.

### BRIEF DESCRIPTION OF THE DRAWINGS

For the purpose of illustrating the invention, the drawings show aspects of one or more embodiments of the invention. However, it should be understood that the present invention is not limited to the precise arrangements and instrumentalities shown in the drawings, wherein:

FIG. 1 is a block diagram illustrating an exemplary embodiment of a video coding system;

FIG. 2 is a block diagram illustrating an exemplary embodiment of a video coding for machines system;

FIG. 3 is a block diagram illustrating an exemplary system for optimizing a loss function for video coding for machines;

FIG. 4 is a block diagram illustrating another exemplary system for optimizing a loss function for video coding for machines;

FIG. 5 illustrates an exemplary process of optimizing a loss function for video coding for machines;

FIG. 6 illustrates another exemplary process of optimizing a loss function for video coding for machines;

FIG. 7 illustrates exemplary machine-learning processes by way of a block diagram;

FIG. 8 is a block diagram illustrating an exemplary embodiment of a video decoder;

FIG. 9 is a block diagram illustrating an exemplary embodiment of a video encoder;

FIG. 10 is a flow diagram illustrating an exemplary method of optimizing a loss function with a rate-distortion cost for video coding for machines; and

FIG. 11 is a block diagram of a computing system that can be used to implement any one or more of the methodologies disclosed herein and any one or more portions thereof.

The drawings are not necessarily to scale and may be illustrated by phantom lines, diagrammatic representations and fragmentary views. In certain instances, details that are not necessary for an understanding of the embodiments or that render other details difficult to perceive may have been omitted.

### DETAILED DESCRIPTION

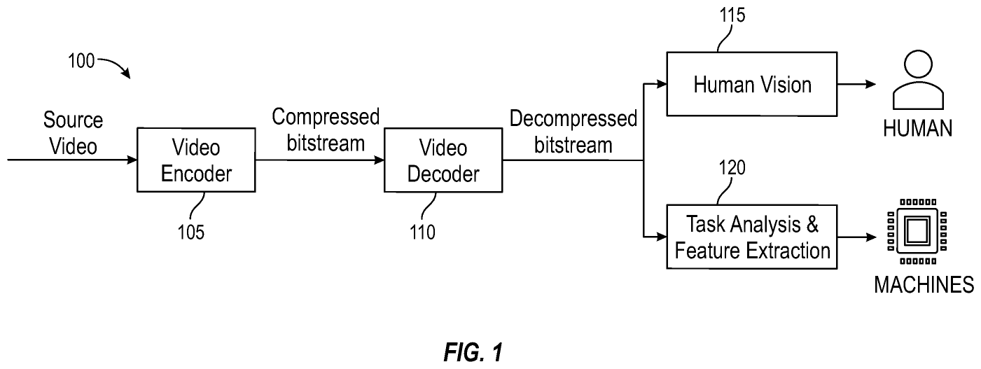

In many applications, such as surveillance systems with multiple cameras, intelligent transportation, smart city applications, and/or intelligent industry applications, traditional video coding may require compression of large number of videos from cameras and transmission through a network to machines and for human consumption. Subsequently, at a machine site, algorithms for feature extraction may applied typically using convolutional neural networks or deep learning techniques including object detection, event action recognition, pose estimation and others. FIG. 1 shows an exemplary embodiment of a standard video coding/decoding system applied for machines. The system is described herein in the context of the VVC encoding standard, but it will be appreciated that other standard video coding protocols, such as HEVC and AV1 can be used in the alternative. The system 100 includes a video encoder 105 which provides a compressed bitstream over a channel to video decoder 110 which decompresses the bitstream and, preferably, provides video for human vison 115 and task analysis and feature extraction 120 suitable for machine applications. Conventional approaches unfortunately, may require a massive video transmission from multiple cameras, which may take significant time for efficient and fast real-time analysis and decision-making. In embodiments, a video coding for machine consumption (“VCM”) approach may resolve this problem by both encoding video and extracting some features at a transmitter site and then transmitting a resultant encoded bit stream to a VCM decoder. At a decoder site video may be decoded for human vision and features may be decoded for machines.

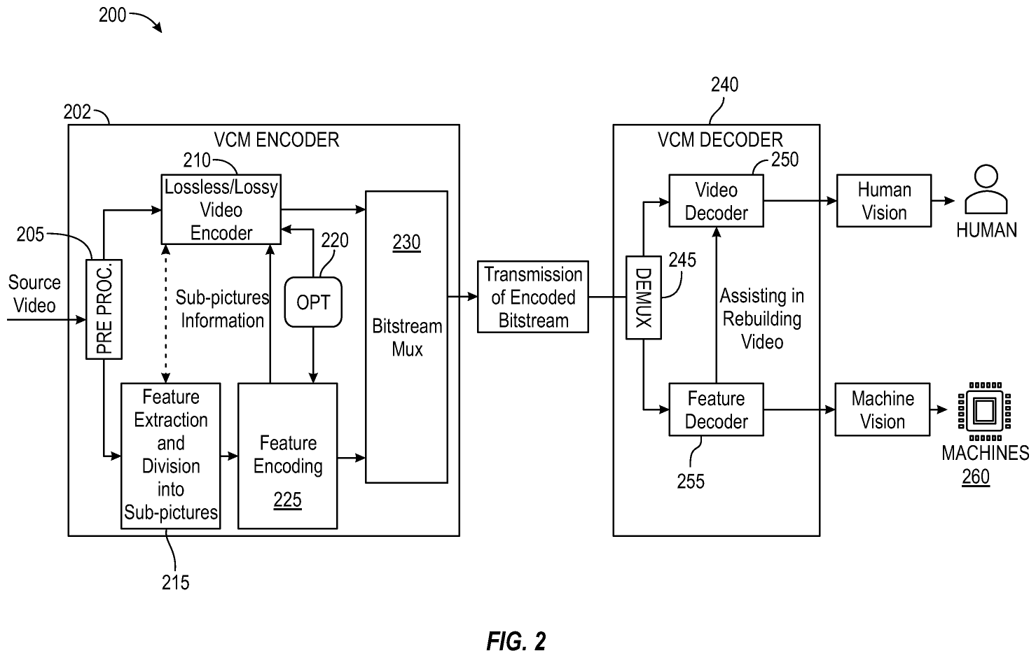

Referring now to FIG. 2, an exemplary embodiment of encoder 202 for video coding for machines is illustrated. VCM encoder 202 may be implemented using any circuitry including without limitation digital and/or analog circuitry; VCM encoder 202 may be configured using hardware configuration, software configuration, firmware configuration, and/or any combination thereof. VCM encoder may be implemented as a computing device and/or as a component of a computing device, which may include without limitation any computing device as described below. In an embodiment, VCM encoder may be configured to receive an input video and generate an output bitstream. Reception of an input video may be accomplished in any manner described below. A bitstream may include, without limitation, any bitstream as described below.

VCM encoder 202 may include, without limitation, a pre-processor 205, a video encoder 210, a feature extractor 215, an optimizer 220, a feature encoder 225, and/or a multiplexor 230. Pre-processor 205 may receive input video stream and parse out video, audio and metadata sub-streams of the stream. Pre-processor 205 may include and/or communicate with decoder as described in further detail below; in other words, Pre-processor 205 may have an ability to decode input streams. This may allow, in a non-limiting example, decoding of an input video, which may facilitate downstream pixel-domain analysis.

Further referring to FIG. 2, VCM encoder 202 may operate in a hybrid mode and/or in a video mode; when in the hybrid mode VCM encoder may be configured to encode a visual signal that is intended for human consumers, to encode a feature signal that is intended for machine consumers; machine consumers may include, without limitation, any devices and/or components, including without limitation computing devices as described in further detail below. Input signal may be passed, for instance when in hybrid mode, through pre-processor.

Still referring to FIG. 2, video encoder may include without limitation any video encoder as described in further detail below. When VCM encoder is in hybrid mode, VCM encoder may send unmodified input video to video encoder and a copy of the same input video, and/or input video that has been modified in some way, to feature extractor. Modifications to input video may include any scaling, transforming, or other modification that may occur to persons skilled in the art upon reviewing the entirety of this disclosure. For instance, and without limitation, input video may be resized to a smaller resolution, a certain number of pictures in a sequence of pictures in input video may be discarded, reducing framerate of the input video, color information may be modified, for example and without limitation by converting an RGB video might be converted to a grayscale video, or the like.

Still referring to FIG. 2, video encoder 210 and feature extractor 215 are preferably connected and might exchange useful information in both directions. For example, and without limitation, video encoder 210 may transfer motion estimation information to feature extractor 215, and vice-versa. Video encoder 210 may provide Quantization mapping and/or data descriptive thereof based on regions of interest (ROI), which video encoder and/or feature extractor may identify, to feature extractor, or vice-versa. Video encoder 210 may provide to feature extractor data describing one or more partitioning decisions based on features present and/or identified in input video, input signal, and/or any frame and/or subframe thereof; feature extractor may provide to video encoder data describing one or more partitioning decisions based on features present and/or identified in input video, input signal, and/or any frame and/or subframe thereof. Video encoder feature extractor may share and/or transmit to one another temporal information for optimal group of pictures (GOP) decisions. Each of these techniques and/or processes may be performed, without limitation, as described in further detail below.

With continued reference to FIG. 2, feature extractor 215 may operate in an offline mode or in an online mode. Feature extractor 215 may identify and/or otherwise act on and/or manipulate features. A “feature,” as used in this disclosure, is a specific structural and/or content attribute of data. Examples of features may include SIFT, audio features, color hist, motion hist, speech level, loudness level, or the like. Features may be time stamped. Each feature may be associated with a single frame of a group of frames. Features may include high level content features such as timestamps, labels for persons and objects in the video, coordinates for objects and/or regions-of-interest, frame masks for region-based quantization, and/or any other feature that may occur to persons skilled in the art upon reviewing the entirety of this disclosure. As a further non-limiting example, features may include features that describe spatial and/or temporal characteristics of a frame or group of frames. Examples of features that describe spatial and/or temporal characteristics may include motion, texture, color, brightness, edge count, blur, blockiness, or the like. When in offline mode, all machine models as described in further detail below may be stored at encoder and/or in memory of and/or accessible to encoder. Examples of such models may include, without limitation, whole or partial convolutional neural networks, keypoint extractors, edge detectors, salience map constructors, or the like. When in online mode one or more models may be communicated to feature extractor by a remote machine in real time or at some point before extraction.

Still referring to FIG. 2, feature encoder 225 is configured for encoding a feature signal, for instance and without limitation as generated by feature extractor 215. In an embodiment, after extracting the features, feature extractor 215 may pass extracted features to feature encoder 225. Feature encoder 225 may use entropy coding and/or similar techniques, for instance and without limitation as described below, to produce a feature stream, which may be passed to multiplexor 230. Video encoder 210 and/or feature encoder may be connected via optimizer 220. Optimizer 220 may exchange useful information between those video encoder 210 and feature encoder 225. For example, and without limitation, information related to codeword construction and/or length for entropy coding may be exchanged and reused, via optimizer, for optimal compression.

In an embodiment, and continuing to refer to FIG. 2, video encoder 210 may produce a video stream; video stream may be passed to multiplexor 230. Multiplexor 230 may multiplex video stream with a feature stream generated by feature encoder 225; alternatively or additionally, video and feature bitstreams may be transmitted over distinct channels, distinct networks, to distinct devices, and/or at distinct times or time intervals (time multiplexing). Each of video stream and feature stream may be implemented in any manner suitable for implementation of any bitstream as described in this disclosure. In an embodiment, multiplexed video stream and feature stream may produce a hybrid bitstream, which may be is transmitted as described in further detail below.

Still referring to FIG. 2, where VCM encoder 202 is in video mode, VCM encoder may use video encoder for both video and feature encoding. Feature extractor 215 may transmit features to video encoder 210; the video encoder 210 may encode features into a video stream that may be decoded by a corresponding video decoder. It should be noted that VCM encoder may use a single video encoder for both video encoding and feature encoding, in which case it may use different set of parameters for video and features; alternatively, VCM encoder may two separate video encoders, which may operate in parallel.

Still referring to FIG. 2, system may include and/or communicate with, a VCM decoder 240. VCM decoder and/or elements thereof may be implemented using any circuitry and/or type of configuration suitable for configuration of VCM encoder as described above. VCM decoder may include, without limitation, a demultiplexor 245. Demultiplexor 245 may operate to demultiplex bitstreams if multiplexed as described above; for instance and without limitation, demultiplexor may separate a multiplexed bitstream containing one or more video bitstreams and one or more feature bitstreams into separate video and feature bitstreams.

Continuing to refer to FIG. 2, VCM decoder may include a video decoder 250. Video decoder 250 may be implemented, without limitation in any manner suitable for a decoder as described in further detail below. In an embodiment, and without limitation, video decoder 250 may generate an output video, which may be viewed by a human or other creature and/or device having visual sensory abilities.

Still referring to FIG. 2, VCM decoder may include a feature decoder 255. In an embodiment, and without limitation, feature decoder may be configured to provide one or more decoded data to a machine. Machine may include, without limitation, any computing device as described below, including without limitation any microcontroller, processor, embedded system, system on a chip, network node, or the like. Machine may operate, store, train, receive input from, produce output for, and/or otherwise interact with a machine model as described in further detail below. Machine may be included in an Internet of Things (IOT), defined as a network of objects having processing and communication components, some of which may not be conventional computing devices such as desktop computers, laptop computers, and/or mobile devices. Objects in IoT may include, without limitation, any devices with an embedded microprocessor and/or microcontroller and one or more components for interfacing with a local area network (LAN) and/or wide-area network (WAN); one or more components may include, without limitation, a wireless transceiver, for instance communicating in the 2.4-2.485 GHz range, like BLUETOOTH transceivers following protocols as promulgated by Bluetooth SIG, Inc. of Kirkland, Wash, and/or network communication components operating according to the MODBUS protocol promulgated by Schneider Electric SE of Rueil-Malmaison, France and/or the ZIGBEE specification of the IEEE 802.15.4 standard promulgated by the Institute of Electronic and Electrical Engineers (IEEE). Persons skilled in the art, upon reviewing the entirety of this disclosure, will be aware of various alternative or additional communication protocols and devices supporting such protocols that may be employed consistently with this disclosure, each of which is contemplated as within the scope of this disclosure.

With continued reference to FIG. 2, each of VCM encoder 202 and/or VCM decoder 240 may be designed and/or configured to perform any method, method step, or sequence of method steps in any embodiment described in this disclosure, in any order and with any degree of repetition. For instance, each of VCM encoder and/or VCM decoder may be configured to perform a single step or sequence repeatedly until a desired or commanded outcome is achieved; repetition of a step or a sequence of steps may be performed iteratively and/or recursively using outputs of previous repetitions as inputs to subsequent repetitions, aggregating inputs and/or outputs of repetitions to produce an aggregate result, reduction or decrement of one or more variables such as global variables, and/or division of a larger processing task into a set of iteratively addressed smaller processing tasks. Each of VCM encoder 202 and/or VCM decoder 240 may perform any step or sequence of steps as described in this disclosure in parallel, such as simultaneously and/or substantially simultaneously performing a step two or more times using two or more parallel threads, processor cores, or the like; division of tasks between parallel threads and/or processes may be performed according to any protocol suitable for division of tasks between iterations. Persons skilled in the art, upon reviewing the entirety of this disclosure, will be aware of various ways in which steps, sequences of steps, processing tasks, and/or data may be subdivided, shared, or otherwise dealt with using iteration, recursion, and/or parallel processing.

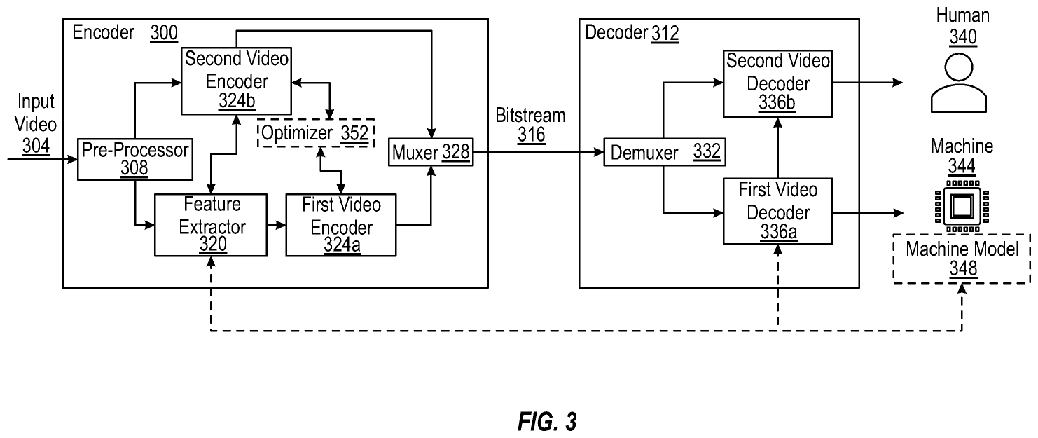

Referring now to FIG. 3, an exemplary system for optimizing a loss function is illustrated by way of a block diagram. System may include an encoder 300. Encoder 300 may include any encoder described in this disclosure. System 300 may receive an input video 304. In some cases, encoder 300 may include a pre-processor 308. As used in this disclosure, a “pre-processor” is a component that converts information, such as without limitation an image, a video, a feature map, and the like, into a representation suitable for subsequent processing. Pre-processor 308 may convert input video 304 into a representation suitable for feature extraction. Pre-processor 308 may include any pre-processor described in this disclosure, for example with reference to FIG. 2. In some cases, to achieve this end, pre-processor 308 may reduce spatial and/or temporal resolution of video. Reduced spatial and/or temporal resolution may reduce complexity of subsequent processing. An exemplary non-limiting pre-processor 308 includes a down-scaler, which reduces resolution of input video 304, for instance by a given factor. For example, an exemplary down-scaler 308 can take as input 1920×1080 pixel video and scale it down to 1280×720 pixel video. In another example, a down-scaler 308 can take as input a 50 frames-per-second video and produce a 25 frames-per-second video, for instance by removing every other frame. Pre-processor 308 may use any pre-determined filters. In some cases, pre-processor parameters, for example filter coefficients, may be available for both encoder 300 and decoder 312. Coefficients can be implicitly or explicitly signaled by encoder 300, for example as part of a bitstream 316 header. Pre-processor 308 may not be limited to use of filters. In some cases, pre-processor 308 may apply any function (e.g., a standard-compliant function). Pre-processor parameters may be associated with any function. Pre-processor parameters may be signaled to decoder 312, for instance either implicitly or explicitly. Pre-processor parameters may be signaled by way of bitstream 316.

With continued reference to FIG. 3, pre-processed video from pre-processor 308 may be input to a feature extractor 320. As used in this disclosure, a “feature extractor” is a component that determines, extracts, or recognizes features within information, such as without limitation a picture and/or a video. In some cases, feature extractor 320 may transform pre-processed video input into feature space. In some cases, pre-processed video may be represented in a pixel domain. In some cases, feature extractor 320 may transform pre-processed video into features. Features may include any features described in this disclosure. In some cases, features may be salient for a machine task. For example, feature extractor 320 may include without limitation a simple edge detector, face detector, color detector, and the like. Alternatively or additionally, feature extractor 320 may include a more complex system that is modeled for more complicated tasks, such as without limitation object detection, motion tracking, event detection, and the like. In some cases, feature extractor 320 may include a machine-learning process, such as any machine-learning process described in this disclosure. Feature extractor 320 may include a Convolutional Neural Network (CNN) which takes images as input and outputs feature maps. As used in this disclosure, a “feature map” is a representation of features, for example within a picture or video. In some cases, a feature map may be represented as matrices of values. In some cases, feature maps can be depicted as a lower resolution, usually grayscale, patches of images. In some cases, feature map may preserve some aspects of input video 304 and/or pre-processed input video and represent a certain level of information about the input video 304 and/or pre-processed input video. In some embodiments of scalable video coding for machines, preservation of information from input video 304 within feature map may be utilized to represent video signal as a sum of base feature signal and a residual signal. As used in this disclosure, a “feature layer” is coded information representative of at least a feature within a video. As used in this disclosure, a “visual layer” is coded information that represents visual information of video, for example for a human viewer. In some cases, dimensions of 2-dimensional (2D) output matrices from feature extractor 320 can have a similar size as an input picture input to feature extractor. Alternatively or additionally, 2D output matrices from feature extractor 320 can be smaller than an input picture. In some cases, feature maps may represent rectangular parts (i.e., patches) of an original picture, which when combined can span substantially some or all of a picture's width and height.

With continued reference to FIG. 3, encoder 300 may include at least a video encoder 324a-b. For instance, a first video encoder 324a may take as input output from feature extractor 320. In some cases, a first video encoder 324a may include a feature encoder. As used in this disclosure, “feature encoder” is a component that encodes features. Feature encoder 324a may include any known feature encoding method or tool, for example any described in this disclosure. Exemplary encoding tools include, without limitation, temporal prediction, transform, quantization, and entropy coding.

With continued reference to FIG. 3, in some cases, input video 304 may be encoded into a visual layer, such as without limitation by a second video encoder 324b, for example after being processed by a pre-processor 308. Second video encoder 324b may include a standard video encoder. For example, second video encoder 324b may include a full implementation of a Versatile Video Coding (VVC) encoder, or a reduced-complexity version that implements a subset of VVC tools. In general, structure of second video encoder 324b may be similar to that of first video encoder 324a and may, for example, include one or more of temporal prediction, transform, quantization, and entropy coding.

With continued reference to FIG. 3, encoder 300 may include a multiplexer or muxer 328. As used in this disclosure, a “muxer” or “multiplexor” is a component that receives more than one signal and outputs one signal. In some cases, muxer 328 may accept as inputs coded features and coded visuals, for example at least a feature layer and at least a visual layer, from first video encoder 324a and second video encoder 324b, respectively. Muxer 328 may combine streams into a bitstream 316 and add necessary information to bitstream header. As used in this disclosure, “header” is an information structure that contains information related to a video component, such as without limitation at least a feature layer and at least a visual layer. In some embodiments, bitstream 316 may include at least a header, at least a feature layer, and at least a visual layer.

With continued reference to FIG. 3, in some cases, decoder 312 may include components that compute inverse operations of encoder 300, for example without limitation entropy decoding, inverse quantization, inverse transform, and residual addition. Decoder 312 may receive a bitstream 316. Decoder 312 may include a demultiplexer or demuxer 332. As used in this disclosure, a “demuxer” or “demultiplexor” is a component that takes in a single signal and outputs multiple signals. In some cases, demuxer 332 may take bitstream 316 as an input and parses and split out feature layer (FL) and at least a visual layer (VL). In some cases, information about how many streams are present in bitstream 316 may be stored in bitstream header. Header may also be parsed by demuxer 332.

With continued reference to FIG. 3, decoder 312 may include at least a video decoder 336a-b. In some cases, a first video decoder 336a may receive a feature layer, for example from demuxer 332. First video decoder 336a may include a feature decoder. As described in this disclosure, a “feature decoder” is a component that decodes features. In some cases, encoder 300 may include a feature decoder in order to ascertain or model what information may be available from coded features (e.g., feature layer) at a decoder 312. In some cases, a feature decoder implemented within encoder may be included within a decoder model. As used in this disclosure, a “decoder model” is a component that models performance of a decoder 312 within a system, for example without limitation an encoder 300 or another decoder 312. Implementation of decoder model, in some cases, may ensure that there is no discrepancy and/or drift between one or more of input signal 304, encoded signal, and decoded signal.

With continued reference to FIG. 3, decoder 312 may include a second video decoder 336b. Second video decoder 336b may take as input a coded visual layer and may decode the coded visual layer, outputting an output video. In some cases, output video may be a human-viewable video. As used in this disclosure, a “human-viewable video” is a video stream that is suitable for human 340 viewing, i.e., human consumption and not machine consumption. Second video decoder 336b may have a similar structure to first video decoder 336a. In some cases, at least a video decoder 336a-b may include a standard video decoder, such as a VVC decoder with a full or a limited set of tools.

With continued reference to FIG. 3, decoder 312 may include pre-processor inverter. As used in this disclosure, “pre-processor inverter” is a component that inversely pre-processes information, including without limitation images, videos, and the like. As used in this disclosure, “inversely pre-processing” is an act of performing an inverse of a pre-processing, i.e., undoing a pre-processing act. Pre-processor inverter may implement an exact inverse of pre-processor. For example without limitation, pre-processor inverter may upscale a down-scaled information stream by using identical filters to that applied by pre-processor 308. In some cases, pre-processor invertor may be a part of a decoder model within encoder 300.

With continued reference to FIG. 3, system may be configured for video coding for machines. As a result system may output a signal to at least a machine 344. “Machine,” as used in this disclosure may include any computing device. Machine 344 may be considered as a different customer for decoded video signals than humans 340. In some cases, features may be output from decoder 312 and/or first video decoder 336a to a machine model 348. Machine model 348 may include any machine learning process described in this disclosure, including for example a machine learning model.

With continued reference to FIG. 3, system may include an optimizer 352. As used in this disclosure, an “optimizer” is a component that varies at least a parameter of at least a process to improve an outcome. In some cases, optimizer 352 may be configured to optimize at least a feature extraction parameter. As used in this disclosure, a “feature extraction parameter” is a factor that contributes to performance of feature extractor 320. In some cases, feature extractor 320 may include a model or process and feature extraction parameter may include a model weightings or process settings. In some cases, optimizer 352 may include at least a loss function. As used in this disclosure, a “loss function” is an expression that represents performance of a process. Loss function may represent different functional aspects of system. For example, a loss function may represent performance of feature extractor 320 and/or performance of at least a video encoder 324a-b.

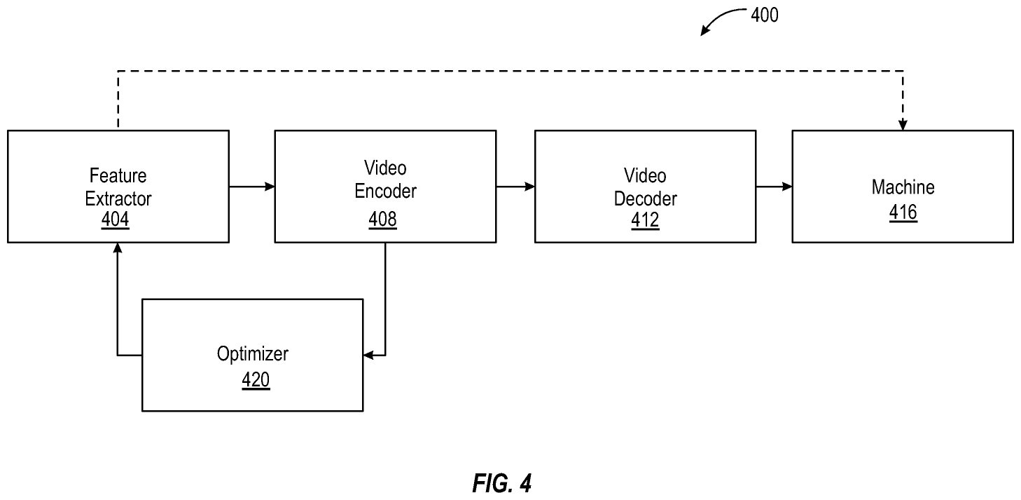

Referring now to FIG. 4, an exemplary system 400 for optimizing a loss function for video coding for machines is illustrated by way of a block diagram. System 400 may include a feature extractor 404. As described above, feature extractor 404 may receive as input an input video, for example output from a pre-processor. Feature extractor 404 may extract at least a feature from input video and, for example, generate and output a feature map. Output from feature extractor 404 may be input to a video encoder 408. Video encoder 408 may include any video encoder described in this disclosure. Output from video encoder may be input to a video decoder 412. Video decoder 412 may include any video decoder described in this disclosure. As described above, output from video decoder 412 may be transmitted to a machine 416. Machine 416, in some case, may be operating a model or process using features extracted by feature extractor 404.

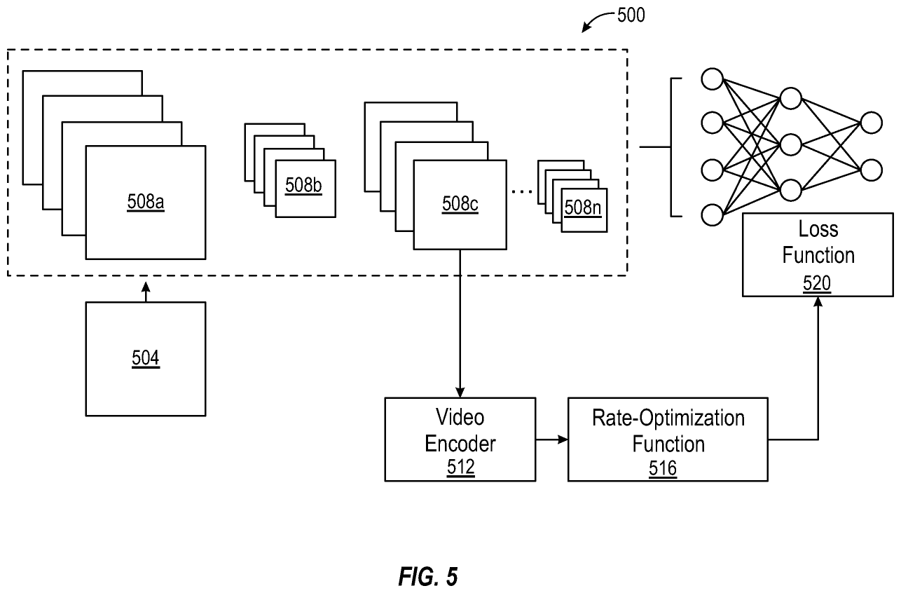

Still referring to FIG. 4, in some embodiments, feature extractor 404 and/or extracting feature map includes a feature extraction machine learning process. As used in this disclosure, a “feature extraction machine learning process” is a machine learning process configured to extract features from an input video and/or image. Feature extraction machine learning process may include any machine learning process described in this disclosure, for example with reference to FIGS. 5-7 below.

Still referring to FIG. 4, in some cases, feature extractor 404 may be applied to help make a determination about a scene, space, and/or object. For example, in some cases a machine 416 may be used for world modeling or registration of objects within a space. In some cases, registration may include image processing, such as without limitation object recognition, feature detection, edge/corner detection, and the like. Non-limiting example of feature detection may include scale invariant feature transform (SIFT), Canny edge detection, Shi Tomasi corner detection, and the like. In some cases, registration may include one or more transformations to orient an image or video stream relative a three-dimensional coordinate system; exemplary transformations include without limitation homography transforms and affine transforms. In an embodiment, registration of first frame to a coordinate system may be verified and/or corrected using object identification and/or machine learning processes, as described throughout this disclosure. For instance, and without limitation, an initial registration to two dimensions, represented, without limitation, as registration to the x and y coordinates, may be performed using a two-dimensional projection of points in three dimensions onto a first frame. A third dimension of registration, representing depth and/or a z axis, may be detected by comparison of two frames. This may be repeated with multiple objects in field of view, including without limitation environmental features of interest identified by object classifier and/or indicated by an operator. In an embodiment, x and y axes may be chosen to span a plane common to input image 304 and/or an xy plane of a first frame; a result, x and y translational components and ϕ may be pre-populated in translational and rotational matrices, for affine transformation of coordinates of object. Initial x and y coordinates and/or guesses at transformational matrices may alternatively or additionally be performed between first frame and second frame. Z coordinates, and/or x, y, and z coordinates, registered using image capturing and/or object identification processes as described above may then be compared to coordinates predicted using initial guess at transformation matrices; an error function may be computed by comparing the two sets of points, and new x, y, and/or z coordinates, may be iteratively estimated and compared until the error function drops below a threshold level.

With continued reference to FIG. 4, system 400 may additionally include an optimizer 420. Optimizer 420 may include any optimizer described in this disclosure, for example with reference to FIG. 3. In some cases, optimizer 420 may include a loss function. Optimizer 420 may be configured to optimize feature extraction parameters of feature extractor 404, as a function of loss function. In some cases, optimizer 420 may take as input outputs from one or more feature extractor 404, video encoder 408, video decoder 412, and machine 416.

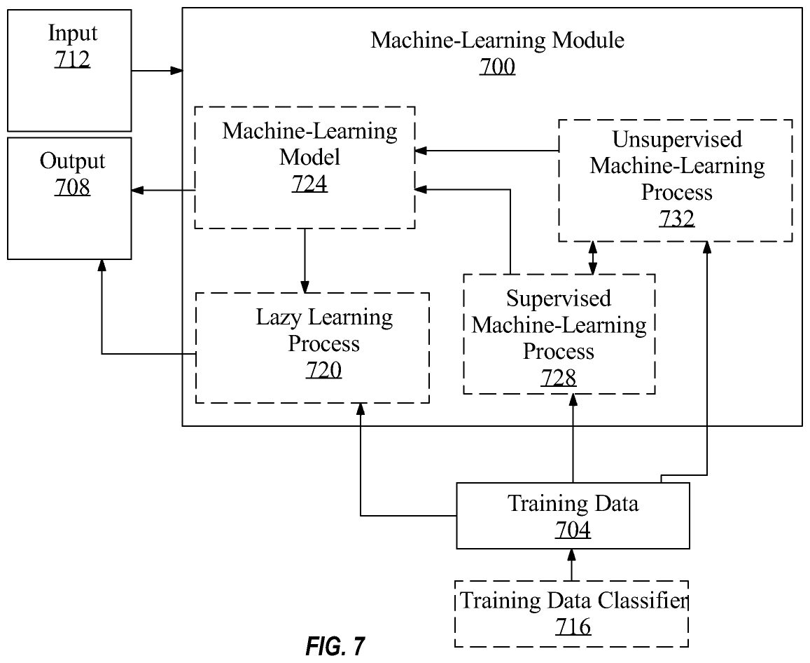

With continued reference to FIG. 4, in some cases, feature extractor 404 may extract a feature map as a function of input video and feature extraction parameters. Video encoder 408 may encode a feature layer as a function of feature map. Optimizer 420 may calculate a loss function as a function of feature layer. In some cases, optimizer 420 may optimize feature extraction parameters as a function of loss function. Optimization of feature extraction parameters may proceed using any method described in this disclosure, including without limitation those described with reference to FIG. 7 below, optimization algorithms, such as without limitation simplex algorithm, combinatorial algorithms, quantum optimization algorithms, and the like, iterative methods, such as without limitation finite difference-base methods (e.g., Newton's method, sequential quadratic programming, interior point methods, and the like), gradient evaluation methods (e.g., coordinate descent methods, conjugate gradient methods, gradient descent methods, sub-gradient methods, ellipsoid methods, conditional gradient method (Frank-Wolfe), Quasi-Newton methods, simultaneous perturbation stochastic approximation methods, and the like, gradient-based evaluation methods of evaluating continuously differentiable functions, such as interpolation methods, pattern search methods and the like, global convergence methods, heuristics, such as memetic algorithm, differential evolution, evolutionary algorithms dynamic relaxation, genetic algorithms, hill climbing, Nelder-Mead simplicial heuristic, particle swarm optimization, gravitation search algorithm, simulated annealing, stochastic tunneling, tabu search, reactive search optimization, forest optimization algorithm, and the like.

Still referring to FIG. 4, in some cases, optimizer 420 and/or optimizing feature extraction parameters may include an optimization machine learning process. As used in this disclosure, an “optimization machine learning process” is any machine learning process that performs an optimization (e.g., maximization, minimization, target-seeking, and the like) process. Optimization machine learning process may include any machine learning process described in this disclosure, for example with reference to FIG. 7 below, constant learning rate algorithms (e.g., stochastic gradient descent [SGD]), and adaptive learning algorithms (e.g., Adagrad, Adadelta, RMSprop, Adam, and the like).

Still referring to FIG. 4, in some embodiments, loss function may include a summation of errors. An exemplary loss function includes

$$L = {\sum }_{i} l ( {y}_{i} , f ( {x}_{i} , θ ) )$$

where L is a loss function that is optimized substantially by way of minimization, l is an error function, yᵢ is a target value, and f(xᵢ,θ) is an estimated value for target value. In some cases, a total loss function, L, may aggregate (e.g., sum) all errors for a number of samples, i. Feature extraction may be optimized until loss function is within a threshold. Threshold may be predetermined. Alternatively or additionally, in some cases threshold may be adaptively determined for instance iteratively or coincidentally with optimization.

Still referring to FIG. 4, in some embodiments, loss function may include a rate-distortion optimization function. As used in this disclosure, a “rate-distortion optimization function” is representation of video compression. In some cases, a rate-distortion optimization function may substantially be minimized during video encoding. An exemplary loss function with a rate-distortion optimization function includes

$$LR = {\sum }_{i} l ( {y}_{i} , f ( {x}_{i} , θ ) + r ( R , D ) )$$

where LR is a loss function with rate-distortion optimization that is optimized substantially by way of minimization, l is an error function, yᵢ is a target value, f(xᵢ,θ) is an estimated value for target value, and r(R,D) is a rate-distortion optimization function.

Still referring to FIG. 4, in some cases, encoding decisions may be made by video encoder to result in highest quality output image. However, in some cases, optimizing for highest quality output image may have a disadvantage that encoding decisions may be made that require more data, while giving comparatively little quality benefit. One common example of this problem is in motion estimation, such as without limitation quarter pixel-precision motion estimation. For example, in some cases, adding extra precision to motion of a block during motion estimation may increase quality, but in some cases the increased quality may prove too costly, in terms of data.

Still referring to FIG. 4, in some cases, rate-distortion optimization may solve aforementioned problem by optimizing a video quality metric, which measures both deviation from source material and bit cost for video coding decisions. In some cases, rate-distortion optimization function may mathematically represent bit costs affects relative distortion by multiplying the bit cost by a Lagrangian. In some cases, a Lagrangian may include a value representing a relationship between bit cost and quality for a particular quality level. In some cases, deviation from source may be measured as a mean squared error. In some cases, calculating bit cost may require rate-distortion optimization function to pass each block of video to be tested to entropy coder to measure its actual bit cost. For example, an exemplary process may consist of a discrete cosine transform, followed by quantization and entropy encoding. For this reason, in some cases, rate-distortion optimization may be much slower than most other block-matching metrics, such as simple sum of absolute differences (SAD) and sum of absolute transformed differences (SATD).

In some cases, a total loss function, LR, may aggregate (e.g., sum) all errors for a number of samples, i. An exemplary rate-distortion optimization function includes

$$r ( R + D ) = D + λ R$$

where D is a measure of distortion, for example between input video and encoded video, R is a measure of bit cost, and λ is a Lagrangian operator. In some cases, Lagrangian operator may represent a relationship between bit cost and quality. As a result, Lagrangian operator may be used to constrain optimization, for example as a function of desired video quality level.

Still referring to FIG. 4, in some embodiments, rate-distortion optimization function may aggregate a distortion metric and a compression metric. As used in this disclosure, a “distortion metric” is a measure of deviation in quality between an input video and a coded video. For example, distortion metric may include D in the above equation. As used in this disclosure, a “compression metric” is a measure of amount of data required for video coding. For example compression metric may include λR in the above equation. According to some embodiments, optimizing a rate-distortion optimization function may improve video quality of resulting coded video. In some cases, rate-distortion optimization may include optimization of a distortion metric against a compression metric.

Still referring to FIG. 4, in some embodiments, system 400 may signal a machine parameter to machine 416. As used in this disclosure, a “machine parameter” is any parameter that machine 416 uses in processes output from video decoder 416. In some cases, machine parameter may be a function of optimized feature extraction parameters. For instance, machine parameters may allow a machine model of machine 416 to process features extracted by feature extractor 404, using optimized feature extraction parameters. In some cases, system 400 may signal a machine parameter in a bitstream, for example with a header of bitstream.

Referring now to FIG. 5, an exemplary optimization process 500 using a loss function for video coding for machines is illustrated by way of a block diagram. In some cases, a feature extractor may take an input picture 504 as input. Feature extractor may extract feature maps 508a-n. In some case, feature extractor may use a process or model, such as a feature extraction machine learning process to extract and produce feature maps 508a-n. In some cases, feature extraction machine-learning process may include a convolutional neural network (CNN). In some cases input video 504 may be input to a feature extractor, which produces feature maps 508a-n. Resulting feature maps 508a-n may include multiple layers, which may represent different levels of abstraction. In some cases, a single layer of feature maps 508c, for instance representing a particular level of abstraction may be selected and passed to a video encoder 512.

With continued reference to FIG. 5, in some cases, video encoder 512 may be used to calculate a rate-distortion optimization function 516. For example, to calculate rate-distortion optimization function 516, video encoder can employ full encoding. Alternatively or additionally, video encoder can employ more efficient encoding, for example to estimate an estimated rate-distortion optimization function 516 approximating an actual rate-distortion optimization function 516. In some cases, to increase efficiency, video encoder 512 may downscale pictures and/or use only sub-set of pictures (e.g., every other picture [50%]). In some cases, video encoder 512 can conduct fast-mode encoding which does not employ all encoding tools. Rate-distortion optimization function 516 may be incorporated within a loss function 520. Loss function 520 may include any loss function 520 described in this disclosure. In some cases, a loss function 520 may be optimized by an optimizer. Optimizer may include an optimization machine learning process. In some cases, optimization machine learning process may include one or more of a convolutional neural network (CNN) and a deep neural network (DNN). In some cases, CNN-DNN may optimize parameters, for example feature extraction parameters and/or video encoder parameters, in order to optimize loss function 520. In some cases, loss function 520 may be used for a process of backpropagation which calculates optimal values for feature extraction parameters and/or video encoder parameters. In some cases, optimization process proceeds until a threshold value of loss function 520 is achieved. Once loss function 520 has been optimized, resulting parameters (e.g., feature extraction parameters and/or video encoder parameters) are used to extract optimized feature maps. Then, optimized feature maps may be encoder with video encoder 512, for instance with optimized video encoder parameters. As described above, in some cases, an optimized output feature layer may be output from video encoder 512, muxed with other streams in an output bitstream, and output from VCM encoder.

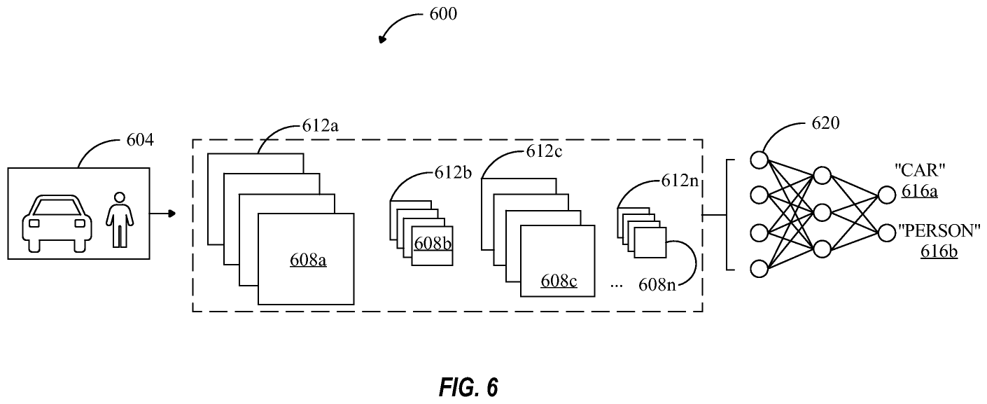

Referring now to FIG. 6 another exemplary optimization process 600 for a loss function for video coding for machines is illustrated by way of a block diagram. Process 600 illustrates a functional application of this technology where feature extraction may be used for downstream object recognition by a machine. For instance, an exemplary input image 604 may include a person and a car. Input image 604 may be received by a feature extractor. In some cases, feature extractor may include a feature extraction machine learning process. In some cases, feature extraction machine learning process may include a convolutional neural network. In some cases, feature extractor may generate multiple sets of feature maps 608a-n. For instance, each set of feature maps 608a-n may correspond with different layers 612a-n of feature extraction. Each layer 612a-n may correspond with different levels of abstraction. For instance, in some cases, input image 604 may include an array having a width and a height (W×H). A first layer 612a may include a first convolutional layer and may yield first feature maps 608a having a first convolutional width and a first convolutional height (C1_W×C1_H). A second layer 612b may include a first pooling layer and may yield second feature maps 608b having a first pooling width and a first pooling height (PL_W×P1_H). A third layer 612c may include an nth convolutional layer and may yield third feature maps 608c having an nth convolutional width and an nth convolutional height (Cn_W×Cn_H). A fourth layer 612n may include an nth pooling layer and may yield fourth feature maps 612n having an nth pooling width and an nth pooling height (Pn_W×Pn_H).

With continued reference to FIG. 6, in some case, one or more of feature extractor and/or machine may take an input picture 604 and output an identification of a car and/or a person, for instance is one or more of car and person are within the input picture 604. As described above, feature extractor may transform input image 604 into feature maps 608a-n, for example by using convolution and subsequent pooling. In some cases, a last pooled layer 608n may be passed as an input (e.g., vector input) to a machine learning process. In some cases, machine learning process may be intended yield a machine learning model for operation on a machine, for instance a machine ultimately downstream of a VCM decoder. machine learning process may include an optimization machine learning process. As described above, optimization machine learning process may be used to optimize a loss function.

With continued reference to FIG. 6, in some cases optimization process 600 may include training of one or more of machine learning model 620, feature extraction machine learning model, and/or optimization machine learning model. During training, optimization machine learning process may use a loss function to assign correct feature extraction parameters and/or machine learning parameters associated with machine learning process 620. In some cases, feature extraction parameters may include layer 612a-n parameters or weightings. Loss function may include any loss function described in this disclosure. As, a VCM encoder may have a dual task of achieving correct feature representation with a minimal bitstream size, loss function may include a joint loss function (i.e., a total loss function) that includes calculations representative of video compression (e.g., rate-distortion optimization function). In some cases, feature extractor may contain a machine learning model that is trained and optimized with joint loss function. In some embodiments, training (i.e., learning) process can be done offline or online. In some cases, training can be implemented in feature extractor. Alternatively or additionally, training can be implemented at machine (i.e., end-user) side. In the latter case, training may be conducted at remotely and optimized parameters may be transmitted to feature extractor and/or machine, for instance as an update.

Referring now to FIG. 7, an exemplary embodiment of a machine-learning module 700 that may perform one or more machine-learning processes as described in this disclosure is illustrated. Machine-learning module may perform determinations, classification, and/or analysis steps, methods, processes, or the like as described in this disclosure using machine learning processes. A “machine learning process,” as used in this disclosure, is a process that automatedly uses training data 704 to generate an algorithm that will be performed by a computing device/module to produce outputs 708 given data provided as inputs 712; this is in contrast to a non-machine learning software program where the commands to be executed are determined in advance by a user and written in a programming language.

Still referring to FIG. 7, “training data,” as used herein, is data containing correlations that a machine-learning process may use to model relationships between two or more categories of data elements. For instance, and without limitation, training data 704 may include a plurality of data entries, each entry representing a set of data elements that were recorded, received, and/or generated together; data elements may be correlated by shared existence in a given data entry, by proximity in a given data entry, or the like. Multiple data entries in training data 704 may evince one or more trends in correlations between categories of data elements; for instance, and without limitation, a higher value of a first data element belonging to a first category of data element may tend to correlate to a higher value of a second data element belonging to a second category of data element, indicating a possible proportional or other mathematical relationship linking values belonging to the two categories. Multiple categories of data elements may be related in training data 704 according to various correlations; correlations may indicate causative and/or predictive links between categories of data elements, which may be modeled as relationships such as mathematical relationships by machine-learning processes as described in further detail below. Training data 704 may be formatted and/or organized by categories of data elements, for instance by associating data elements with one or more descriptors corresponding to categories of data elements. As a non-limiting example, training data 704 may include data entered in standardized forms by persons or processes, such that entry of a given data element in a given field in a form may be mapped to one or more descriptors of categories. Elements in training data 704 may be linked to descriptors of categories by tags, tokens, or other data elements; for instance, and without limitation, training data 704 may be provided in fixed-length formats, formats linking positions of data to categories such as comma-separated value (CSV) formats and/or self-describing formats such as extensible markup language (XML), JavaScript Object Notation (JSON), or the like, enabling processes or devices to detect categories of data.

Alternatively or additionally, and continuing to refer to FIG. 7, training data 704 may include one or more elements that are not categorized; that is, training data 704 may not be formatted or contain descriptors for some elements of data. Machine-learning algorithms and/or other processes may sort training data 704 according to one or more categorizations using, for instance, natural language processing algorithms, tokenization, detection of correlated values in raw data and the like; categories may be generated using correlation and/or other processing algorithms. As a non-limiting example, in a corpus of text, phrases making up a number “n” of compound words, such as nouns modified by other nouns, may be identified according to a statistically significant prevalence of n-grams containing such words in a particular order; such an n-gram may be categorized as an element of language such as a “word” to be tracked similarly to single words, generating a new category as a result of statistical analysis. Similarly, in a data entry including some textual data, a person's name may be identified by reference to a list, dictionary, or other compendium of terms, permitting ad-hoc categorization by machine-learning algorithms, and/or automated association of data in the data entry with descriptors or into a given format. The ability to categorize data entries automatedly may enable the same training data 704 to be made applicable for two or more distinct machine-learning algorithms as described in further detail below. Training data 704 used by machine-learning module 700 may correlate any input data as described in this disclosure to any output data as described in this disclosure. As a non-limiting illustrative example inputs may include input video and/or images and outputs may include known features, such as identifications (e.g., person identification, face identification, and the like).

Further referring to FIG. 7, training data may be filtered, sorted, and/or selected using one or more supervised and/or unsupervised machine-learning processes and/or models as described in further detail below; such models may include without limitation a training data classifier 716. Training data classifier 716 may include a “classifier,” which as used in this disclosure is a machine-learning model as defined below, such as a mathematical model, neural net, or program generated by a machine learning algorithm known as a “classification algorithm,” as described in further detail below, that sorts inputs into categories or bins of data, outputting the categories or bins of data and/or labels associated therewith. A classifier may be configured to output at least a datum that labels or otherwise identifies a set of data that are clustered together, found to be close under a distance metric as described below, or the like. Machine-learning module 700 may generate a classifier using a classification algorithm, defined as a processes whereby a computing device and/or any module and/or component operating thereon derives a classifier from training data 704. Classification may be performed using, without limitation, linear classifiers such as without limitation logistic regression and/or naive Bayes classifiers, nearest neighbor classifiers such as k-nearest neighbors classifiers, support vector machines, least squares support vector machines, fisher's linear discriminant, quadratic classifiers, decision trees, boosted trees, random forest classifiers, learning vector quantization, and/or neural network-based classifiers. As a non-limiting example, training data classifier 716 may classify elements of training data to depending upon machine or application of machine using VCM encoded video.

Still referring to FIG. 7, machine-learning module 700 may be configured to perform a lazy-learning process 720 and/or protocol, which may alternatively be referred to as a “lazy loading” or “call-when-needed” process and/or protocol, may be a process whereby machine learning is conducted upon receipt of an input to be converted to an output, by combining the input and training set to derive the algorithm to be used to produce the output on demand. For instance, an initial set of simulations may be performed to cover an initial heuristic and/or “first guess” at an output and/or relationship. As a non-limiting example, an initial heuristic may include a ranking of associations between inputs and elements of training data 704. Heuristic may include selecting some number of highest-ranking associations and/or training data 704 elements. Lazy learning may implement any suitable lazy learning algorithm, including without limitation a K-nearest neighbors algorithm, a lazy naïve Bayes algorithm, or the like; persons skilled in the art, upon reviewing the entirety of this disclosure, will be aware of various lazy-learning algorithms that may be applied to generate outputs as described in this disclosure, including without limitation lazy learning applications of machine-learning algorithms as described in further detail below.

Alternatively or additionally, and with continued reference to FIG. 7, machine-learning processes as described in this disclosure may be used to generate machine-learning models 724. A “machine-learning model,” as used in this disclosure, is a mathematical and/or algorithmic representation of a relationship between inputs and outputs, as generated using any machine-learning process including without limitation any process as described above, and stored in memory; an input is submitted to a machine-learning model 724 once created, which generates an output based on the relationship that was derived. For instance, and without limitation, a linear regression model, generated using a linear regression algorithm, may compute a linear combination of input data using coefficients derived during machine-learning processes to calculate an output datum. As a further non-limiting example, a machine-learning model 724 may be generated by creating an artificial neural network, such as a convolutional neural network comprising an input layer of nodes, one or more intermediate layers, and an output layer of nodes. Connections between nodes may be created via the process of “training” the network, in which elements from a training data 704 set are applied to the input nodes, a suitable training algorithm (such as Levenberg-Marquardt, conjugate gradient, simulated annealing, or other algorithms) is then used to adjust the connections and weights between nodes in adjacent layers of the neural network to produce the desired values at the output nodes. This process is sometimes referred to as deep learning.

Still referring to FIG. 7, machine-learning algorithms may include at least a supervised machine-learning process 728. At least a supervised machine-learning process 728, as defined herein, include algorithms that receive a training set relating a number of inputs to a number of outputs, and seek to find one or more mathematical relations relating inputs to outputs, where each of the one or more mathematical relations is optimal according to some criterion specified to the algorithm using some scoring function. For instance, a supervised learning algorithm may include a loss function derived from an encoded feature layer as described above as inputs, and feature extraction parameters as outputs, and a scoring function representing a desired form of relationship to be detected between inputs and outputs; scoring function may, for instance, seek to maximize the probability that a given input and/or combination of elements inputs is associated with a given output to minimize the probability that a given input is not associated with a given output. Scoring function may be expressed as a risk function representing an “expected loss” of an algorithm relating inputs to outputs, where loss is computed as an error function representing a degree to which a prediction generated by the relation is incorrect when compared to a given input-output pair provided in training data 704. Persons skilled in the art, upon reviewing the entirety of this disclosure, will be aware of various possible variations of at least a supervised machine-learning process 728 that may be used to determine relation between inputs and outputs. Supervised machine-learning processes may include classification algorithms as defined above.

Further referring to FIG. 7, machine learning processes may include at least an unsupervised machine-learning processes 732. An unsupervised machine-learning process, as used herein, is a process that derives inferences in datasets without regard to labels; as a result, an unsupervised machine-learning process may be free to discover any structure, relationship, and/or correlation provided in the data. Unsupervised processes may not require a response variable; unsupervised processes may be used to find interesting patterns and/or inferences between variables, to determine a degree of correlation between two or more variables, or the like.

Still referring to FIG. 7, machine-learning module 700 may be designed and configured to create a machine-learning model 724 using techniques for development of linear regression models. Linear regression models may include ordinary least squares regression, which aims to minimize the square of the difference between predicted outcomes and actual outcomes according to an appropriate norm for measuring such a difference (e.g. a vector-space distance norm); coefficients of the resulting linear equation may be modified to improve minimization. Linear regression models may include ridge regression methods, where the function to be minimized includes the least-squares function plus term multiplying the square of each coefficient by a scalar amount to penalize large coefficients. Linear regression models may include least absolute shrinkage and selection operator (LASSO) models, in which ridge regression is combined with multiplying the least-squares term by a factor of 1 divided by double the number of samples. Linear regression models may include a multi-task lasso model wherein the norm applied in the least-squares term of the lasso model is the Frobenius norm amounting to the square root of the sum of squares of all terms. Linear regression models may include the elastic net model, a multi-task elastic net model, a least angle regression model, a LARS lasso model, an orthogonal matching pursuit model, a Bayesian regression model, a logistic regression model, a stochastic gradient descent model, a perceptron model, a passive aggressive algorithm, a robustness regression model, a Huber regression model, or any other suitable model that may occur to persons skilled in the art upon reviewing the entirety of this disclosure. Linear regression models may be generalized in an embodiment to polynomial regression models, whereby a polynomial equation (e.g. a quadratic, cubic or higher-order equation) providing a best predicted output/actual output fit is sought; similar methods to those described above may be applied to minimize error functions, as will be apparent to persons skilled in the art upon reviewing the entirety of this disclosure.

Continuing to refer to FIG. 7, machine-learning algorithms may include, without limitation, linear discriminant analysis. Machine-learning algorithm may include quadratic discriminate analysis. Machine-learning algorithms may include kernel ridge regression. Machine-learning algorithms may include support vector machines, including without limitation support vector classification-based regression processes. Machine-learning algorithms may include stochastic gradient descent algorithms, including classification and regression algorithms based on stochastic gradient descent. Machine-learning algorithms may include nearest neighbors algorithms. Machine-learning algorithms may include various forms of latent space regularization such as variational regularization. Machine-learning algorithms may include Gaussian processes such as Gaussian Process Regression. Machine-learning algorithms may include cross-decomposition algorithms, including partial least squares and/or canonical correlation analysis. Machine-learning algorithms may include naïve Bayes methods. Machine-learning algorithms may include algorithms based on decision trees, such as decision tree classification or regression algorithms. Machine-learning algorithms may include ensemble methods such as bagging meta-estimator, forest of randomized tress, AdaBoost, gradient tree boosting, and/or voting classifier methods. Machine-learning algorithms may include neural net algorithms, including convolutional neural net processes.

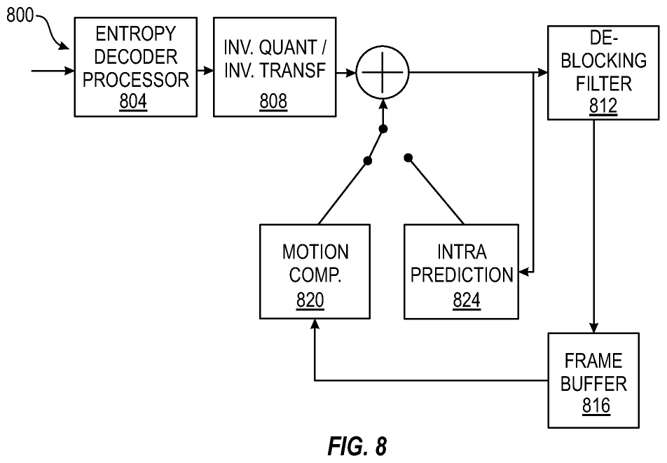

FIG. 8 is a system block diagram illustrating an example decoder 800 capable of adaptive cropping. Decoder 800 may include an entropy decoder processor 804, an inverse quantization and inverse transformation processor 808, a deblocking filter 812, a frame buffer 816, a motion compensation processor 820 and/or an intra prediction processor 824.

In operation, and still referring to FIG. 8, bit stream 828 may be received by decoder 800 and input to entropy decoder processor 804, which may entropy decode portions of bit stream into quantized coefficients. Quantized coefficients may be provided to inverse quantization and inverse transformation processor 808, which may perform inverse quantization and inverse transformation to create a residual signal, which may be added to an output of motion compensation processor 820 or intra prediction processor 824 according to a processing mode. An output of the motion compensation processor 820 and intra prediction processor 824 may include a block prediction based on a previously decoded block. A sum of prediction and residual may be processed by deblocking filter 812 and stored in a frame buffer 816.

In an embodiment, and still referring to FIG. 8 decoder 800 may include circuitry configured to implement any operations as described above in any embodiment as described above, in any order and with any degree of repetition. For instance, decoder 800 may be configured to perform a single step or sequence repeatedly until a desired or commanded outcome is achieved; repetition of a step or a sequence of steps may be performed iteratively and/or recursively using outputs of previous repetitions as inputs to subsequent repetitions, aggregating inputs and/or outputs of repetitions to produce an aggregate result, reduction or decrement of one or more variables such as global variables, and/or division of a larger processing task into a set of iteratively addressed smaller processing tasks. Decoder may perform any step or sequence of steps as described in this disclosure in parallel, such as simultaneously and/or substantially simultaneously performing a step two or more times using two or more parallel threads, processor cores, or the like; division of tasks between parallel threads and/or processes may be performed according to any protocol suitable for division of tasks between iterations. Persons skilled in the art, upon reviewing the entirety of this disclosure, will be aware of various ways in which steps, sequences of steps, processing tasks, and/or data may be subdivided, shared, or otherwise dealt with using iteration, recursion, and/or parallel processing.

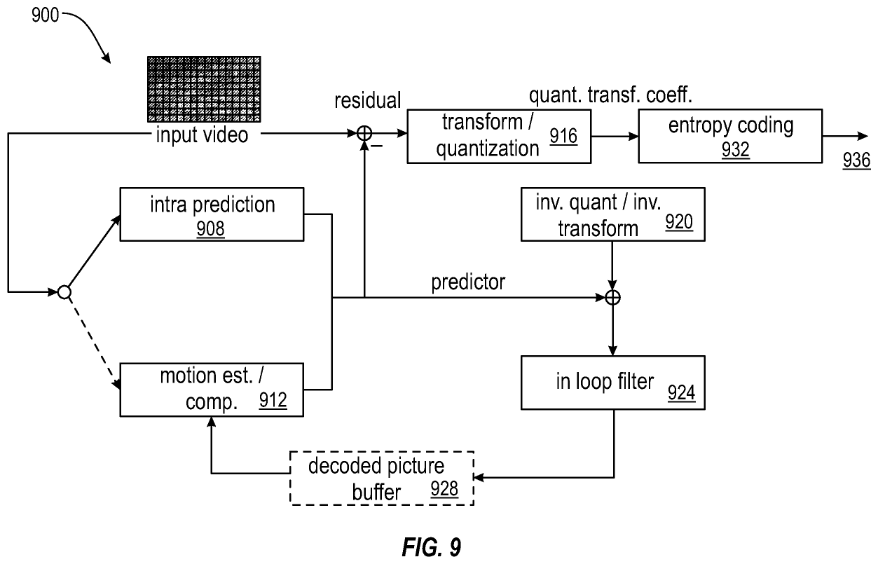

FIG. 9 is a system block diagram illustrating an example video encoder 900 capable of adaptive cropping. Example video encoder 900 may receive an input video 904, which may be initially segmented or dividing according to a processing scheme, such as a tree-structured macro block partitioning scheme (e.g., quad-tree plus binary tree). An example of a tree-structured macro block partitioning scheme may include partitioning a picture frame into large block elements called coding tree units (CTU). In some implementations, each CTU may be further partitioned one or more times into a number of sub-blocks called coding units (CU). A final result of this portioning may include a group of sub-blocks that may be called predictive units (PU). Transform units (TU) may also be utilized.

Still referring to FIG. 9, example video encoder 900 may include an intra prediction processor 908, a motion estimation/compensation processor 912, which may also be referred to as an inter prediction processor, capable of constructing a motion vector candidate list including adding a global motion vector candidate to the motion vector candidate list, a transform/quantization processor 916, an inverse quantization/inverse transform processor 920, an in-loop filter 924, a decoded picture buffer 928, and/or an entropy coding processor 932. Bit stream parameters may be input to the entropy coding processor 932 for inclusion in the output bit stream 936.

In operation, and with continued reference to FIG. 9, for each block of a frame of input video, whether to process block via intra picture prediction or using motion estimation/compensation may be determined. Block may be provided to intra prediction processor 908 or motion estimation/compensation processor 912. If block is to be processed via intra prediction, intra prediction processor 908 may perform processing to output a predictor. If block is to be processed via motion estimation/compensation, motion estimation/compensation processor 912 may perform processing including constructing a motion vector candidate list including adding a global motion vector candidate to the motion vector candidate list, if applicable.

Further referring to FIG. 9, a residual may be formed by subtracting a predictor from input video. Residual may be received by transform/quantization processor 916, which may perform transformation processing (e.g., discrete cosine transform (DCT)) to produce coefficients, which may be quantized. Quantized coefficients and any associated signaling information may be provided to entropy coding processor 932 for entropy encoding and inclusion in output bit stream 936. Entropy encoding processor 932 may support encoding of signaling information related to encoding a current block. In addition, quantized coefficients may be provided to inverse quantization/inverse transformation processor 920, which may reproduce pixels, which may be combined with a predictor and processed by in loop filter 924, an output of which may be stored in decoded picture buffer 928 for use by motion estimation/compensation processor 912 that is capable of constructing a motion vector candidate list including adding a global motion vector candidate to the motion vector candidate list.

With continued reference to FIG. 9, although a few variations have been described in detail above, other modifications or additions are possible. For example, in some implementations, current blocks may include any symmetric blocks (8×8, 16×16, 32×32, 64×64, 128×128, and the like) as well as any asymmetric block (8×4, 16×8, and the like).

In some implementations, and still referring to FIG. 9, a quadtree plus binary decision tree (QTBT) may be implemented. In QTBT, at a Coding Tree Unit level, partition parameters of QTBT may be dynamically derived to adapt to local characteristics without transmitting any overhead. Subsequently, at a Coding Unit level, a joint-classifier decision tree structure may eliminate unnecessary iterations and control the risk of false prediction. In some implementations, LTR frame block update mode may be available as an additional option available at every leaf node of QTBT.

In some implementations, and still referring to FIG. 9, additional syntax elements may be signaled at different hierarchy levels of bitstream. For example, a flag may be enabled for an entire sequence by including an enable flag coded in a Sequence Parameter Set (SPS). Further, a CTU flag may be coded at a coding tree unit (CTU) level.

Some embodiments may include non-transitory computer program products (i.e., physically embodied computer program products) that store instructions, which when executed by one or more data processors of one or more computing systems, cause at least one data processor to perform operations herein.

Still referring to FIG. 9, encoder 900 may include circuitry configured to implement any operations as described above in any embodiment, in any order and with any degree of repetition. For instance, encoder 900 may be configured to perform a single step or sequence repeatedly until a desired or commanded outcome is achieved; repetition of a step or a sequence of steps may be performed iteratively and/or recursively using outputs of previous repetitions as inputs to subsequent repetitions, aggregating inputs and/or outputs of repetitions to produce an aggregate result, reduction or decrement of one or more variables such as global variables, and/or division of a larger processing task into a set of iteratively addressed smaller processing tasks. Encoder 900 may perform any step or sequence of steps as described in this disclosure in parallel, such as simultaneously and/or substantially simultaneously performing a step two or more times using two or more parallel threads, processor cores, or the like; division of tasks between parallel threads and/or processes may be performed according to any protocol suitable for division of tasks between iterations. Persons skilled in the art, upon reviewing the entirety of this disclosure, will be aware of various ways in which steps, sequences of steps, processing tasks, and/or data may be subdivided, shared, or otherwise dealt with using iteration, recursion, and/or parallel processing.

With continued reference to FIG. 9, non-transitory computer program products (i.e., physically embodied computer program products) may store instructions, which when executed by one or more data processors of one or more computing systems, causes at least one data processor to perform operations, and/or steps thereof described in this disclosure, including without limitation any operations described above and/or any operations decoder 900 and/or encoder 900 may be configured to perform. Similarly, computer systems are also described that may include one or more data processors and memory coupled to the one or more data processors. The memory may temporarily or permanently store instructions that cause at least one processor to perform one or more of the operations described herein. In addition, methods can be implemented by one or more data processors either within a single computing system or distributed among two or more computing systems. Such computing systems can be connected and can exchange data and/or commands or other instructions or the like via one or more connections, including a connection over a network (e.g. the Internet, a wireless wide area network, a local area network, a wide area network, a wired network, or the like), via a direct connection between one or more of the multiple computing systems, or the like.

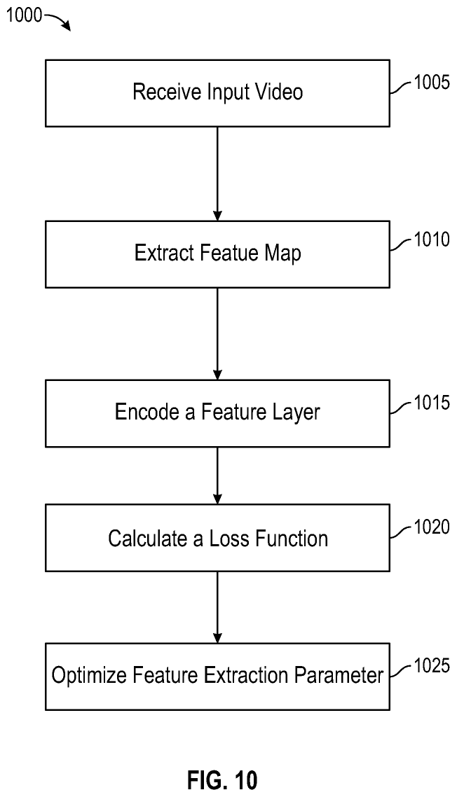

Referring now to FIG. 10, an exemplary method 1000 of optimizing a loss function for video coding for machines is illustrated by way of a flow diagram. At step 1005, method 1000 may include receiving, using a computing device, an input video. Computing device may include any computing device described in this disclosure, including for example with reference to FIGS. 1-9 and 11. Input video may include any video described in this disclosure, including for example with reference to FIGS. 1-9. In some embodiments, computing device may include one or more of a decoder and an encoder. Decoder may include any decoder described in this disclosure, including for example with reference to FIGS. 1-9. Encoder may include any encoder described in this disclosure, including for example with reference to FIGS. 1-9.

With continued reference to FIG. 10, at step 1010 method 1000 may include extracting, using computing device, a feature map as a function of input video and at least a feature extraction parameter. Feature map may include any feature map described in this disclosure, including for example with reference to FIGS. 1-9. Feature extraction parameter may include any feature extraction parameter described in this disclosure, including for example with reference to FIGS. 1-9. In some embodiments, extracting feature map may include a feature extraction machine learning process. Feature extraction machine learning process may include any machine learning process described in this disclosure, including for example with reference to FIGS. 1-9.

With continued reference to FIG. 10, at step 1015, method 1000 may include encoding, using computing device, a feature layer as a function of feature map. Feature layer may include any feature layer described in this disclosure, including for example with reference to FIGS. 1-9.

With continued reference to FIG. 10, at step 1020, method 1000 may include calculating, using computing device, a loss function as a function of base feature layer. Loss function may include any loss function described in this disclosure, including for example with reference to FIGS. 1-9. In some embodiments, loss function may include a rate-distortion optimization function. Rate-distortion optimization function may include any rate-distortion optimization function described in this disclosure, including for example with reference to FIGS. 1-9. In some cases, rate-distortion optimization may aggregate a distortion metric and a compression metric. Distortion metric may include any distortion metric described in this disclosure, including for example with reference to FIGS. 1-9. Compression metric may include any compression metric described in this disclosure, including for example with reference to FIGS. 1-9.

With continued reference to FIG. 10, at step 1025, method 1000 may include optimizing, using computing device, at least a feature extraction parameter as a function of loss function. In some embodiments, optimizing feature extraction parameters may include an optimization machine learning process. Optimization machine learning process may include any optimization machine learning process described in this disclosure, including for example with reference to FIGS. 1-9.

Still referring to FIG. 10, in some embodiments, method 1000 may additionally include extracting, using computing device, an optimized feature map as a function of input video and at least an optimized feature extraction parameter, encoding, using the computing device, an optimized feature layer as a function of the optimized feature map, multiplexing, using the computing device, an output bitstream as a function of the optimized feature layer and at least another layer, and transmitting, using the computing device, the output bitstream, output bitstream may include any bitstream described in this disclosure, including for example with reference to FIGS. 1-9. In some cases, method 1000 may additionally include receiving, using computing device, output bitstream, demultiplexing, using the computing device, optimized feature layer as a function of the output bitstream, and decoding, using the computing device, the optimized feature layer. In some cases, method 1000 additionally includes outputting, using computing device, optimized feature layer to a machine. Machine may include any machine described in this disclosure, including for example with reference to FIGS. 1-9. In some cases, method 1000 may include signaling a machine parameter to machine, wherein the machine parameter is a function of at least an optimized feature extraction parameter. Machine parameter may include any machine parameter described in this disclosure, including for example with reference to FIGS. 1-9.

It is to be noted that any one or more of the aspects and embodiments described herein may be conveniently implemented using one or more machines (e.g., one or more computing devices that are utilized as a user computing device for an electronic document, one or more server devices, such as a document server, etc.) programmed according to the teachings of the present specification, as will be apparent to those of ordinary skill in the computer art. Appropriate software coding can readily be prepared by skilled programmers based on the teachings of the present disclosure, as will be apparent to those of ordinary skill in the software art. Aspects and implementations discussed above employing software and/or software modules may also include appropriate hardware for assisting in the implementation of the machine executable instructions of the software and/or software module.

Such software may be a computer program product that employs a machine-readable storage medium. A machine-readable storage medium may be any medium that is capable of storing and/or encoding a sequence of instructions for execution by a machine (e.g., a computing device) and that causes the machine to perform any one of the methodologies and/or embodiments described herein. Examples of a machine-readable storage medium include, but are not limited to, a magnetic disk, an optical disc (e.g., CD, CD-R, DVD, DVD-R, etc.), a magneto-optical disk, a read-only memory “ROM” device, a random-access memory “RAM” device, a magnetic card, an optical card, a solid-state memory device, an EPROM, an EEPROM, and any combinations thereof. A machine-readable medium, as used herein, is intended to include a single medium as well as a collection of physically separate media, such as, for example, a collection of compact discs or one or more hard disk drives in combination with a computer memory. As used herein, a machine-readable storage medium does not include transitory forms of signal transmission.

Such software may also include information (e.g., data) carried as a data signal on a data carrier, such as a carrier wave. For example, machine-executable information may be included as a data-carrying signal embodied in a data carrier in which the signal encodes a sequence of instruction, or portion thereof, for execution by a machine (e.g., a computing device) and any related information (e.g., data structures and data) that causes the machine to perform any one of the methodologies and/or embodiments described herein.

Examples of a computing device include, but are not limited to, an electronic book reading device, a computer workstation, a terminal computer, a server computer, a handheld device (e.g., a tablet computer, a smartphone, etc.), a web appliance, a network router, a network switch, a network bridge, any machine capable of executing a sequence of instructions that specify an action to be taken by that machine, and any combinations thereof. In one example, a computing device may include and/or be included in a kiosk.

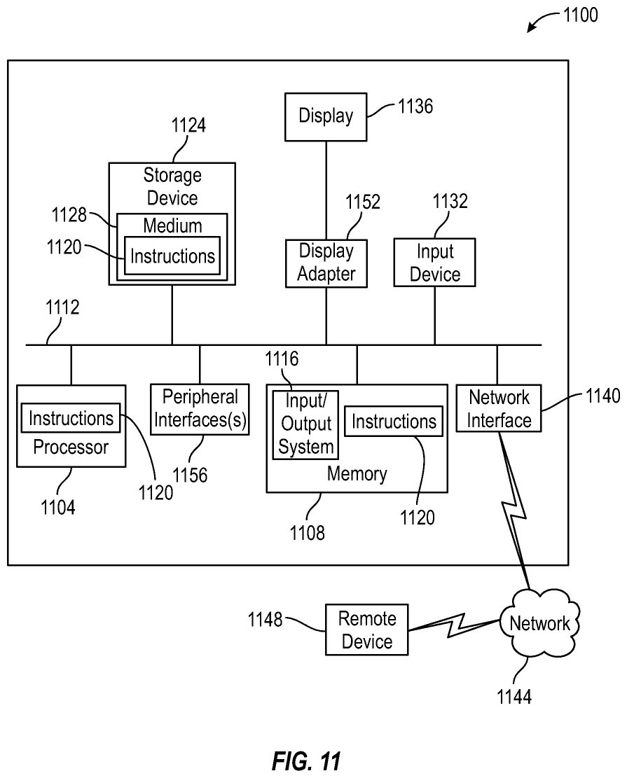

FIG. 11 shows a diagrammatic representation of one embodiment of a computing device in the exemplary form of a computer system 1100 within which a set of instructions for causing a control system to perform any one or more of the aspects and/or methodologies of the present disclosure may be executed. It is also contemplated that multiple computing devices may be utilized to implement a specially configured set of instructions for causing one or more of the devices to perform any one or more of the aspects and/or methodologies of the present disclosure. Computer system 1100 includes a processor 1104 and a memory 1108 that communicate with each other, and with other components, via a bus 1112. Bus 1112 may include any of several types of bus structures including, but not limited to, a memory bus, a memory controller, a peripheral bus, a local bus, and any combinations thereof, using any of a variety of bus architectures.

Processor 1104 may include any suitable processor, such as without limitation a processor incorporating logical circuitry for performing arithmetic and logical operations, such as an arithmetic and logic unit (ALU), which may be regulated with a state machine and directed by operational inputs from memory and/or sensors; processor 1104 may be organized according to Von Neumann and/or Harvard architecture as a non-limiting example. Processor 1104 may include, incorporate, and/or be incorporated in, without limitation, a microcontroller, microprocessor, digital signal processor (DSP), Field Programmable Gate Array (FPGA), Complex Programmable Logic Device (CPLD), Graphical Processing Unit (GPU), general purpose GPU, Tensor Processing Unit (TPU), analog or mixed signal processor, Trusted Platform Module (TPM), a floating-point unit (FPU), and/or system on a chip (SoC).

Memory 1108 may include various components (e.g., machine-readable media) including, but not limited to, a random-access memory component, a read only component, and any combinations thereof. In one example, a basic input/output system 1116 (BIOS), including basic routines that help to transfer information between elements within computer system 1100, such as during start-up, may be stored in memory 1108. Memory 1108 may also include (e.g., stored on one or more machine-readable media) instructions (e.g., software) 1120 embodying any one or more of the aspects and/or methodologies of the present disclosure. In another example, memory 1108 may further include any number of program modules including, but not limited to, an operating system, one or more application programs, other program modules, program data, and any combinations thereof.

Computer system 1100 may also include a storage device 1124. Examples of a storage device (e.g., storage device 1124) include, but are not limited to, a hard disk drive, a magnetic disk drive, an optical disc drive in combination with an optical medium, a solid-state memory device, and any combinations thereof. Storage device 1124 may be connected to bus 1112 by an appropriate interface (not shown). Example interfaces include, but are not limited to, SCSI, advanced technology attachment (ATA), serial ATA, universal serial bus (USB), IEEE 1394 (FIREWIRE), and any combinations thereof. In one example, storage device 1124 (or one or more components thereof) may be removably interfaced with computer system 1100 (e.g., via an external port connector (not shown)). Particularly, storage device 1124 and an associated machine-readable medium 1128 may provide nonvolatile and/or volatile storage of machine-readable instructions, data structures, program modules, and/or other data for computer system 1100. In one example, software 1120 may reside, completely or partially, within machine-readable medium 1128. In another example, software 1120 may reside, completely or partially, within processor 1104.

Computer system 1100 may also include an input device 1132. In one example, a user of computer system 1100 may enter commands and/or other information into computer system 1100 via input device 1132. Examples of an input device 1132 include, but are not limited to, an alpha-numeric input device (e.g., a keyboard), a pointing device, a joystick, a gamepad, an audio input device (e.g., a microphone, a voice response system, etc.), a cursor control device (e.g., a mouse), a touchpad, an optical scanner, a video capture device (e.g., a still camera, a video camera), a touchscreen, and any combinations thereof. Input device 1132 may be interfaced to bus 1112 via any of a variety of interfaces (not shown) including, but not limited to, a serial interface, a parallel interface, a game port, a USB interface, a FIREWIRE interface, a direct interface to bus 1112, and any combinations thereof. Input device 1132 may include a touch screen interface that may be a part of or separate from display 1136, discussed further below. Input device 1132 may be utilized as a user selection device for selecting one or more graphical representations in a graphical interface as described above.

A user may also input commands and/or other information to computer system 1100 via storage device 1124 (e.g., a removable disk drive, a flash drive, etc.) and/or network interface device 1140. A network interface device, such as network interface device 1140, may be utilized for connecting computer system 1100 to one or more of a variety of networks, such as network 1144, and one or more remote devices 1148 connected thereto. Examples of a network interface device include, but are not limited to, a network interface card (e.g., a mobile network interface card, a LAN card), a modem, and any combination thereof. Examples of a network include, but are not limited to, a wide area network (e.g., the Internet, an enterprise network), a local area network (e.g., a network associated with an office, a building, a campus or other relatively small geographic space), a telephone network, a data network associated with a telephone/voice provider (e.g., a mobile communications provider data and/or voice network), a direct connection between two computing devices, and any combinations thereof. A network, such as network 1144, may employ a wired and/or a wireless mode of communication. In general, any network topology may be used. Information (e.g., data, software 1120, etc.) may be communicated to and/or from computer system 1100 via network interface device 1140.

Computer system 1100 may further include a video display adapter 1152 for communicating a displayable image to a display device, such as display device 1136. Examples of a display device include, but are not limited to, a liquid crystal display (LCD), a cathode ray tube (CRT), a plasma display, a light emitting diode (LED) display, and any combinations thereof. Display adapter 1152 and display device 1136 may be utilized in combination with processor 1104 to provide graphical representations of aspects of the present disclosure. In addition to a display device, computer system 1100 may include one or more other peripheral output devices including, but not limited to, an audio speaker, a printer, and any combinations thereof. Such peripheral output devices may be connected to bus 1112 via a peripheral interface 1156. Examples of a peripheral interface include, but are not limited to, a serial port, a USB connection, a FIREWIRE connection, a parallel connection, and any combinations thereof.

The foregoing has been a detailed description of illustrative embodiments of the invention. Various modifications and additions can be made without departing from the spirit and scope of this invention. Features of each of the various embodiments described above may be combined with features of other described embodiments as appropriate in order to provide a multiplicity of feature combinations in associated new embodiments. Furthermore, while the foregoing describes a number of separate embodiments, what has been described herein is merely illustrative of the application of the principles of the present invention. Additionally, although particular methods herein may be illustrated and/or described as being performed in a specific order, the ordering is highly variable within ordinary skill to achieve methods, systems, and software according to the present disclosure. Accordingly, this description is meant to be taken only by way of example, and not to otherwise limit the scope of this invention.

Exemplary embodiments have been disclosed above and illustrated in the accompanying drawings. It will be understood by those skilled in the art that various changes, omissions and additions may be made to that which is specifically disclosed herein without departing from the spirit and scope of the present invention.

What is claimed is:

1. A system for optimizing a loss function for video coding for machines, the system comprising a computing device including circuitry and configured to:
receive an input video;
extract a feature map as a function of the input video and at least a feature extraction parameter;
encode a feature layer as a function of the feature map;
calculate a loss function as a function of the feature layer; and
optimize the at least a feature extraction parameter as a function of the loss function.

2. The system of claim 1, wherein the loss function comprises a rate-distortion optimization function.

3. The system of claim 2, wherein the rate-distortion optimization function aggregates a distortion metric and a compression metric.

4. The system of claim 1, wherein optimizing the feature extraction parameters includes an optimization machine learning process.

5. The system of claim 1, wherein extracting the feature map includes a feature extraction machine learning process.

6. The system of claim 1, wherein the computing device is further configured to:
extract an optimized feature map as a function of the input video and the at least an optimized feature extraction parameter;
encode an optimized feature layer as a function of the optimized feature map;
multiplexing an output bitstream as a function of the optimized base feature layer and at least another layer; and
transmit the output bitstream.

7. The system of claim 6, wherein the computing device is further configured to:
receive the output bitstream;
demultiplex the optimized feature layer as a function of the output bitstream; and
decode the optimized feature layer.

8. The system of claim 7, wherein the computing device is further configured to output the optimized feature layer to a machine.

9. The system of claim 8, wherein the computing device is further configured to signal a machine parameter to the machine, wherein the machine parameter is a function of the at least an optimized feature extraction parameter.

10. The system of claim 1, wherein the computing device comprises one or more of a decoder.

11. A method of optimizing a loss function for video coding for machines, the method comprising:
receiving, using a computing device, an input video;
extracting, using the computing device, a feature map as a function of the input video and at least a feature extraction parameter;
encoding, using the computing device, a feature layer as a function of the feature map;
calculating, using the computing device, a loss function as a function of the base feature layer; and
optimizing, using the computing device, the at least a feature extraction parameter as a function of the loss function.

12. The method of claim 11, wherein the loss function comprises a rate-distortion optimization function.

13. The method of claim 12, wherein the rate-distortion optimization aggregates a distortion metric and a compression metric.

14. The method of claim 11, wherein optimizing the feature extraction parameters includes an optimization machine learning process.

15. The method of claim 11, wherein extracting the feature map includes a feature extraction machine learning process.

16. The method of claim 11, further comprising:
extracting, using the computing device, an optimized feature map as a function of the input video and the at least an optimized feature extraction parameter;
encoding, using the computing device, an optimized feature layer as a function of the optimized feature map;
multiplexing, using the computing device, an output bitstream as a function of the optimized feature layer and at least another layer; and
transmitting, using the computing device, the output bitstream.

17. The method of claim 16, further comprising:
receiving, using the computing device, the output bitstream;
demultiplexing, using the computing device, the optimized feature layer as a function of the output bitstream; and
decoding, using the computing device, the optimized feature layer.

18. The method of claim 17, further comprising outputting, using the computing device, the optimized feature layer to a machine.

19. The method of claim 18, further comprising signaling a machine parameter to the machine, wherein the machine parameter is a function of the at least an optimized feature extraction parameter.

20. The method of claim 11, wherein the computing device comprises one or more of a decoder and an encoder.
